(19) United States
(12) Patent Application Publication
(10) Pub. No.: US 2010/0177418 A1
(43) Pub. Date: Jul. 15, 2010

(54) WRITER AND READER CENTER ALIGNMENT WITH SERVO AND DATA TRACK IN DISCRETE TRACK RECORDING

(75) Inventors: Yawshing Tang, Saratoga, CA (US); Carl Xiaodong Che, Saratoga, CA (US)

Correspondence Address: IRELL & MANELLA LLP, 1800 AVENUE OF THE STARS, SUITE 900, LOS ANGELES, CA, 90067, US

(73) Assignee: Samsung Electronics Co., Ltd., Suwon City (KR)

(21) Appl. No.: 12/353,918

(22) Filed: Jan. 14, 2009

(51) Int. Cl. G11B 27/36; G11B 5/596

(52) U.S. Cl. 360/31; 360/78.04; G9B/5.216; G9B/27.052

(57) ABSTRACT

A hard disk drive with a patterned disk that has a discrete track. The disk drive includes a controller that controls a head and a voice coil motor to optimize a writing of information onto the discrete track. Writing optimization can occur by initially writing a track of information and recording the write position. The written track is then located by reading the information with a read element of a drive head and analyzing a quality of the read signal, such as signal amplitude or error rate. The read position is then recorded. The information is erased and the head is moved. The process of writing, finding the written track location, storing the write and read positions and again moving the head is repeated. The write and read positions that provide the best quality signal is saved and subsequently used to write and read data on the discrete track.

### BACKGROUND OF THE INVENTION

1. Field of the Invention

The subject matter disclosed generally relates to writing data on a patterned media of hard disk drives.

2. Background Information

Hard disk drives contain a plurality of heads that are magnetically coupled to rotating disks. The heads write and read information by magnetizing and sensing the magnetic fields of the disk surfaces. Each head typically has a write element to write information and a separate read element to read information.

Data is written onto a plurality of concentric tracks that extend radially across each disk surface. Each track is typically divided into a plurality of sectors. The disk surfaces contain servo information that is used to properly align the heads with the tracks of the disks.

There are generally two different types of magnetic heads, horizontal recording heads and perpendicular recording heads (“PMR heads”). Horizontal recording heads magnetize the disk in a direction that is essentially parallel with the outer surface of the disk. PMR heads magnetize the disk in a direction essentially perpendicular to the outer surface of the disk. PMR heads are preferred because perpendicular recording allows for higher bit densities and corresponding increases in the data capacity of the drive.

The areal density of perpendicular recording is limited by magnetic cross-talk between adjacent areas of the disks. One approach to limiting cross-talk is to create a disk composed of a plurality of magnetic dots that are separated by non-magnetic material. The non-magnetic material inhibits magnetic cross-talk between the magnetic dots. Such disks are commonly referred to as bit patterned media. It is also possible to have entire tracks that are separated by non-magnetic material, also referred to as discrete track media. Patterned and discrete media have discrete tracks that are physically formed in the disk surfaces. It is preferably to align the write element of a head with the center of each discrete track to maximize magnetization of the material.

The read and write elements within each head are physically offset from each other. The offset must be predetermined to properly align the read element with information written by the write element. The offset is typically determined with techniques that utilize the servo information on the disks. Such techniques typically look for head locations that provide the maximum read signal amplitude and/or lowest error rate. Merely utilizing servo information to determine maximum read signal amplitudes or lowest error rates are not ideal because such an approach does not determine if the write process has written information on the middle of a discrete track. As noted above, it is preferably to write while the head is located on the center of the track to optimize magnetization of the magnetic disk material.

### BRIEF SUMMARY OF THE INVENTION

A hard disk drive that includes a patterned disk with at least one discrete track. The disk drive includes a controller that controls a head and a voice coil motor to optimize a writing of information onto the discrete track.

### BRIEF DESCRIPTION OF THE DRAWINGS

FIG. 1 is a top view of a hard disk drive;

FIG. 2 is a schematic showing an electrical system of the drive;

FIG. 3 is an illustration showing a head relative to discrete data tracks and a servo field of a patterned disk;

FIG. 4 is a flowchart showing a process to optimize writing information on the patterned disk;

FIG. 5 is a flowchart showing an alternate process to optimize writing information on the patterned disk.

### DETAILED DESCRIPTION

Disclosed is a hard disk drive with a patterned disk that has a discrete track. The disk drive includes a controller that controls a head and a voice coil motor, to optimize a writing of information onto the discrete track. Writing optimization can occur by initially writing a track of information and recording the write position. The written track is then located by reading the information with a read element of a drive head and analyzing a quality of the read signal, such as signal amplitude or error rate. The read position is then recorded. The information is erased and the head is moved. The process of writing, finding the written track location, storing the write and read positions and again moving the head is repeated. The write and read positions that provide the best quality signal are saved and subsequently used to write and read data on the discrete track. Such an approach writes information at or close to the center of the discrete track and compensates for read/write element offset.

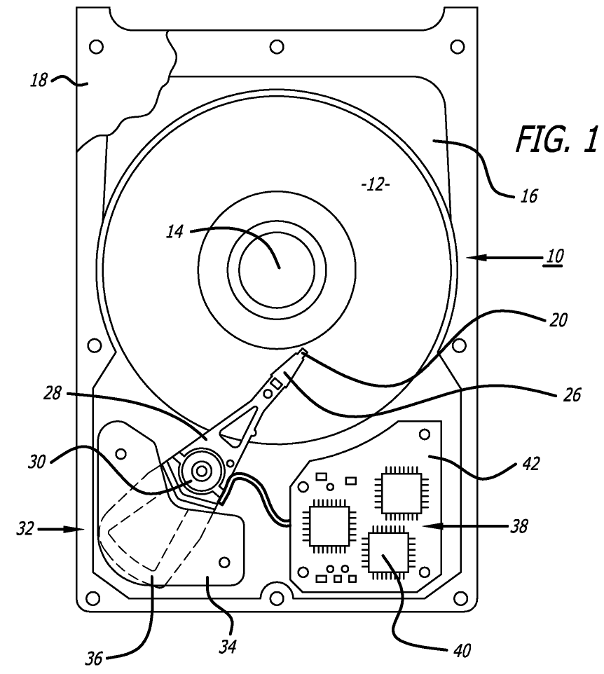

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12. The heads 20 may each have a heater element (not shown) that can vary the flying height of the head. Such heads are commonly referred to as fly on demand (“FOD”) heads. Additionally, the heads can be either horizontal or perpendicular recording type devices, as is known in the art.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

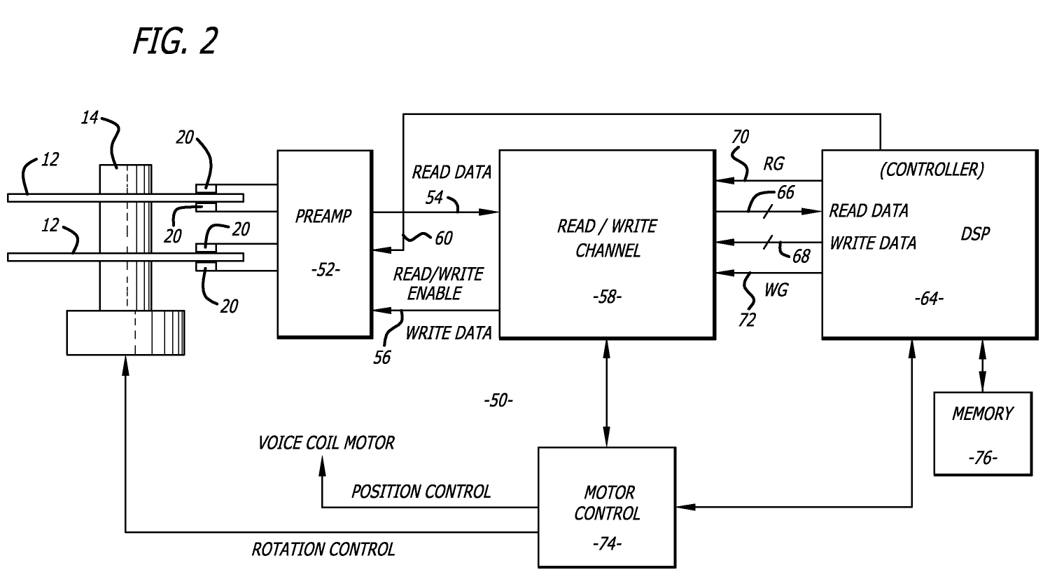

FIG. 2 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the instructions to operate the controller and disk drive. Alternatively, the controller may have embedded firmware to operate the drive.

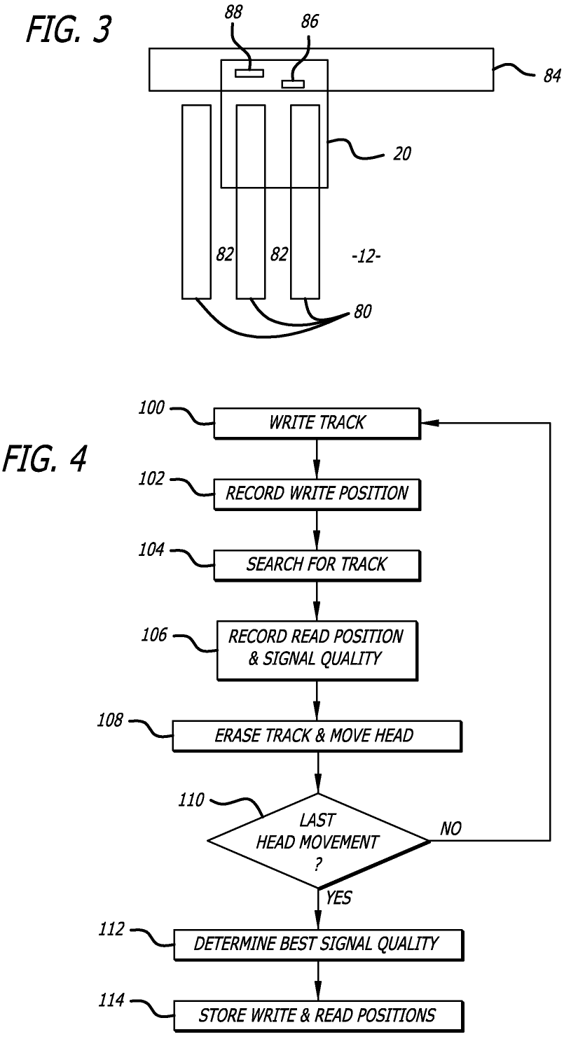

FIG. 3 is an illustration showing a head 20 flying relative to patterned disk 12. The disk 12 is constructed to a have a plurality of discrete tracks 80. The discrete tracks 80 are constructed from a magnetic material. The tracks are separated by areas of non-magnetic material 82. The non-magnetic material limits magnetic cross-talk between tracks. The disk 12 may also have a servo field 84.

The head 20 has a read element 86 and a separate write element 88. To maximize magnetization of the magnetic discrete tracks 80 it is desirable to locate the write element 88 along the center of a track. Likewise, when reading a discrete track it is desirable to center the read element 86 along the center of the track. As shown by FIG. 3, the read element 88 is typically offset from the write element 86.

FIG. 4 is a flowchart that shows a process for the optimization of writing and reading information so that the write and read elements are along the track center, or in close proximity to the center, during write and read operations. In step 100 a track of information is written with the write element. A write position of the head is recorded in step 102. The write position can be determined with track ID information and the servo field.

In step 104 the read element is used to search for the track of information written in step 100. A quality of signal is used to find the track. The quality of signal may be the read signal amplitude and/or error rate of written information. If a track is found (e.g., a read signal is detected) then a read position of the head and the quality of the signal are recorded in step 106.

In step 108, the track is erased and the head 20 is moved relative to the disk. By way of example, the head may be moved a fraction of the track pitch. It is determined whether the head has moved a last iteration in decision block 110. If not, the process returns to step 100, the head is moved another iteration and the process is repeated. If so, the process continues to step 112 where it is determined what write and read positions produced the best quality of signal, such as the highest read signal amplitude and/or lowest error rate. The-write and read positions with the best quality of signal are stored in step 114. The write and read positions are then used to write and read information to and from the discrete track. The process of determining the write and read positions can be repeated for all or a select number of discrete tracks.

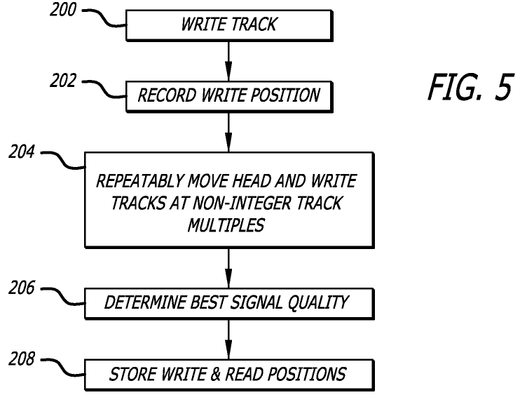

FIG. 5 shows another process embodiment, after the initial write and position record steps 200 and 202, respectively, the head may be moved a non-integer multiple of the track pitch and a new set of information can be written onto a new write track in step 204. The process of moving the head and writing data can be repeated a predetermined number of times. The new set of information may have a different frequency or different data pattern than the initial writing. The head can be sequentially moved to a non-integer multiple of the track pitch, and new information is written after each move. This will create multiple track writings, at least one of which is likely to be centered, or near the center of a discrete track. The read head is then used to find the written track with the best quality of signal in step 206 and the relevant write and read positions are stored in step 208. Different frequencies and/or data patterns are used so that each track can be identified by its unique frequency/pattern.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a patterned disk that includes at least one discrete track;
a spindle motor coupled to said patterned disk;
a head coupled to said patterned disk;
a voice coil motor coupled to said head; and,
a controller coupled to said head and said voice coil motor, said controller controls said head and said voice coil motor to optimize a writing of information onto said discrete track.

2. The disk drive of claim 1, wherein said controller performs a routine wherein a track is written with information and a write position is recorded, said track is then read and a quality of signal and a read positions are recorded, said information is erased, said head is moved and the process is repeated, the write and read positions for the track positions with the highest recorded quality of signal is stored as the write and read positions.

3. The disk drive of claim 2, further comprising writing and reading information using said recorded write and read positions.

4. The disk drive of claim 2, wherein said head is moved a fraction of a track pitch.

5. The disk drive of claim 2, wherein said head is moved a non-integer multiple distance of a track pitch, and said information is varied for each writing of information.

6. The disk drive of claim 5, wherein said information is varied by different frequencies.

7. The disk drive of claim 2, wherein said quality of signal includes a signal amplitude.

8. The disk drive of claim 2, wherein said quality of signal includes an error rate.

9. A hard disk drive, comprising:
a patterned disk that includes at least one discrete track;
a spindle motor coupled to said patterned disk;
a head coupled to said patterned disk;
a voice coil motor coupled to said head; and,
controller means for controlling said head and said voice coil motor to optimize a writing of information onto said discrete track.

10. The disk drive of claim 9, wherein said controller means performs a routine wherein a track is written with information and a write position is recorded, said track is then read and a quality of signal and a read position are recorded, said information is erased, said head is moved and the process is repeated, the write and read positions for the track positions with the highest recorded quality of signal is recorded as the write and read positions.

11. The disk drive of claim 10, further comprising writing and reading information using said recorded write and read positions.

12. The disk drive of claim 10, wherein said head is moved a fraction of a track pitch.

13. The disk drive of claim 10, wherein said head is moved a non-integer multiple distance of a track pitch, and said information is varied for each writing of information.

14. The disk drive of claim 13, wherein said information is varied by different frequencies.

15. The disk drive of claim 10, wherein said quality of signal includes a signal amplitude.

16. The disk drive of claim 10, wherein said quality of signal includes an error rate.

17. A method for writing information onto a patterned disk of a hard disk drive, comprising:
(a) writing information onto a track and recording a track position;
(b) finding the track position with a quality of signal, and recording the track position and quality of signal;
(c) erasing the information;
(d) moving the head;
(e) repeating steps (a)-(d);
(f) recording the write and read position with the best quality of signal; and,
(g) writing data utilizing the write position.

18. The method of claim 17, wherein the head is moved a fraction of a track pitch.

19. A method for writing information onto a patterned disk of a hard disk drive, comprising:
(a) writing information onto a track and recording a track position;
(b) moving the head a non-integer track multiple;
(c) repeating steps (a) and (b) a predetermined number of times;
(d) determining a track position with a best quality of signal;
(e) recording a write position and a read position of the track position with the best quality of signal; and,
(f) writing data utilizing the write position.

20. The method of claim 17, wherein the quality of signal includes a signal amplitude.
